(19) United States
(12) Patent Application Publication
(10) Pub. No.: US 2018/0098652 A1
(43) Pub. Date: Apr. 12, 2018

(54) DRINKING STRAWS FILLED WITH EDIBLE PARTICULATE PRODUCT

(71) Applicant: Ferenc Ecseri, Cegled (HU)

(72) Inventor: Ferenc Ecseri, Cegled (HU)

(21) Appl. No.: 15/566,966

(22) PCT Filed: Dec. 15, 2015
(86) PCT No.: PCT/HU2015/050023

§ 371 Date: Oct. 16, 2017

(30) Foreign Application Priority Data
Apr. 14, 2015 (HU) P1500164

(51) Int. Cl. A47G 21/18

(52) U.S. Cl. CPC A47G 21/183

(57) ABSTRACT

The subject of the invention relates to a drinking straw (10) that contains—a tubular delimiting wall (16), which has an elongate container portion (10c) and open ends (14a, 14b) at opposing sides, —a particulate product (20) disposed within the container portion (10c), which particulate product (20) contains at least one type of active ingredient for the purpose of continuous dispensing into the liquid passing through the drinking straw (10), —a liquid-permeable closing element defining the container portion (10c) and retaining the particulate product (20) in the container portion (10c), the essence of which is that the particulate product (20) contains extruded particles (20a, 20b, 20c, 20d) with a homogenous structure. The subject of the invention also relates to a method for the production of such a drinking straw (10).

The subject of the invention relates to a drinking straw comprising a particulate product from which active ingredients are gradually dissolved into the liquid passing through the drinking straw. The subject of the invention also relates to a method for the production of a drinking straw comprising such particulate product.

According to the state of the art, drinking straws are known of that serve for flavouring various liquids (such as milk, water, etc.) by the flavouring granulates to be found in the drinking straw being dissolved into the liquid flowing through the drinking straw.

In general flavouring drinking straws have a hollow, cylindrical shaped body, which is filled with flavouring particles that are retained in it by filters or sponges disposed at the two ends of the hollow cylinder.

Patent document number U.S. Pat. No. 8,334,003 teaches the use of spherically shaped “nonpareil” particles produced using dragée technology consisting of substantially concentric layers.

The disadvantage of the spherically shaped flavouring particles is that due to the dissolving of the flavouring material or any other active ingredient taking place on the surface of the particles and spheres having the smallest relative surface when compared to other geometric bodies with the same volume, dissolving will be slower. Another disadvantage is that due to the great ability of the spherical flavouring particles disposed within the drinking straw to fill up space, little space remains between the particles, which means there is greater resistance to the flow of liquid. As a consequence of this it is necessary to exert a high pressure drop in order to suck the liquid through the drinking straw, in other words, a consumer must exert a greater amount of suction. A further disadvantage is that the tightly packed spherical particles easily block up the filters located at the ends of the drinking straw. This problem appears gradually as the diameter of the spherical particles or balls is reduced during the dissolving process.

During the nonpareil production of granulates, the flavouring material and/or the active ingredients are applied as a coating to a sugar core. These sugar cores merely perform the function of a carrier, and after the coating is dissolved off them, they become useless in the drinking straw, in other words they do not perform the targeted flavouring function, and also other active ingredients are no longer dissolved from them. A further disadvantage of nonpareil granulates is that there production is a complex and time-consuming process due to the growth of the coating.

The aim of the invention is to provide a device and method that is free of the disadvantages of the solutions according to the state of the art.

The above problems are solved with a drinking straw comprising:
a tubular plastic wall, which has an elongate container portion and open ends at opposing sides,
a particulate product disposed within the container portion, which particulate product comprising at least one type of active ingredient for the purpose of continuous dispensing into the liquid passing through the drinking straw,
a liquid-permeable closing element defining the container portion and retaining the particulate product in the container portion.

The essence of the drinking straw is that the particulate product comprises extruded particles with a homogenous structure.

The particles with a homogenous structure produced by extruding have a non-spherical, irregular shape, which is free of the disadvantages of the flavouring particles according to the state of the art. Over and above this, the extruded particles are easy to produce, and in comparison to spherical particles, their manufacturing cost does not increase either.

A further advantage of the extruded particles, as compared to nonpareil granulates, is that they do not comprise a sugar core that performs the function of a carrier, therefore their structure is homogenous, which provides more even dissolving. By leaving out the unnecessary sugar core more flavouring and/or active material may be filled into the drinking straws, or the same amount of flavouring and/or active material may fit into a smaller drinking straw, which results in a reduction of manufacturing costs.

The subject of the invention also relates to a method for the production of a drinking straw filled with extruded particles with a homogenous structure. The method includes the following steps:
edible dry and wetting ingredients are mixed and a homogenous bulk material is created,
the homogenous bulk material is pressed through an extruder tube,
the bulk material pressed through the extruder tube is cut up into sections creating extruded particles,
the extruded particles cut to size are filled into the container portion of the drinking straw,
the ends of the container portion of the drinking straw are closed with liquid-permeable closing elements.

The individual preferred embodiments of the invention are specified in the sub-claims.

Further details of the invention will be explained by way of exemplary embodiments with reference to the drawings. In the drawings

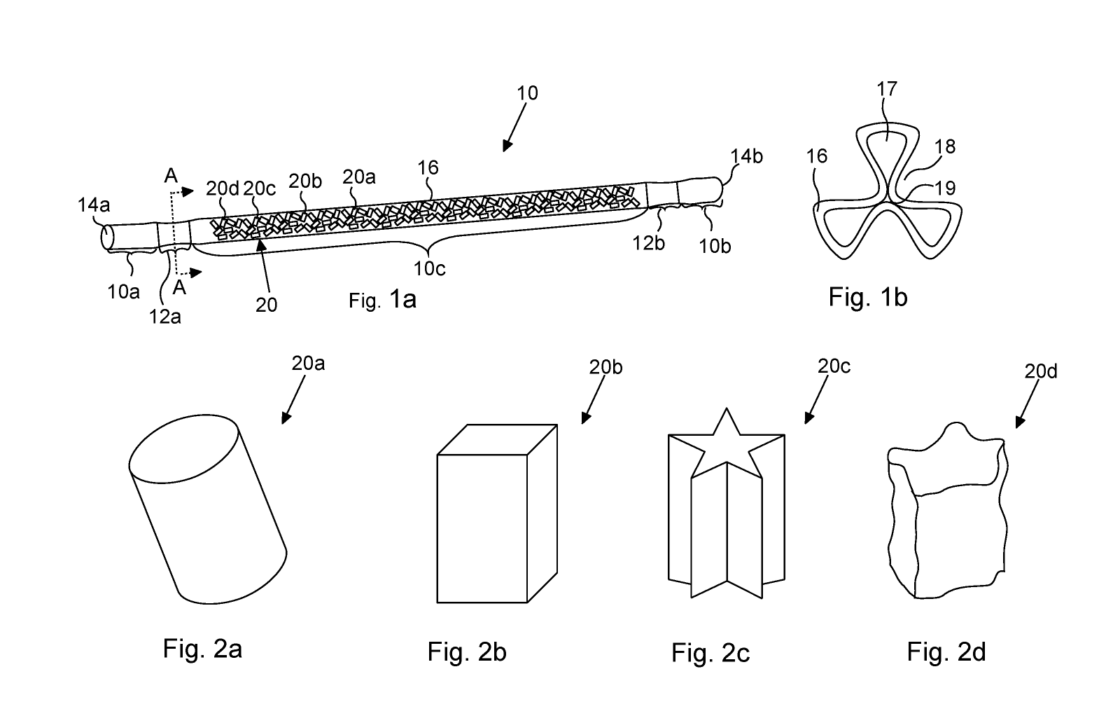

FIG. 1a shows a schematic perspective view of a preferred embodiment of the drinking straw according to the invention,

FIG. 1b shows the A-A cross-sectional view of the drinking straw according to FIG. 1a,

FIG. 2a shows a schematic perspective view of an exemplary embodiment of the extruded particles disposed within the drinking straw,

FIG. 2b shows a schematic perspective view of another exemplary embodiment of the extruded particles disposed within the drinking straw,

FIG. 2c shows a schematic perspective view of yet another exemplary embodiment of the extruded particles disposed within the drinking straw,

FIG. 2d shows a schematic perspective view of a further exemplary embodiment of the extruded particles disposed within the drinking straw,

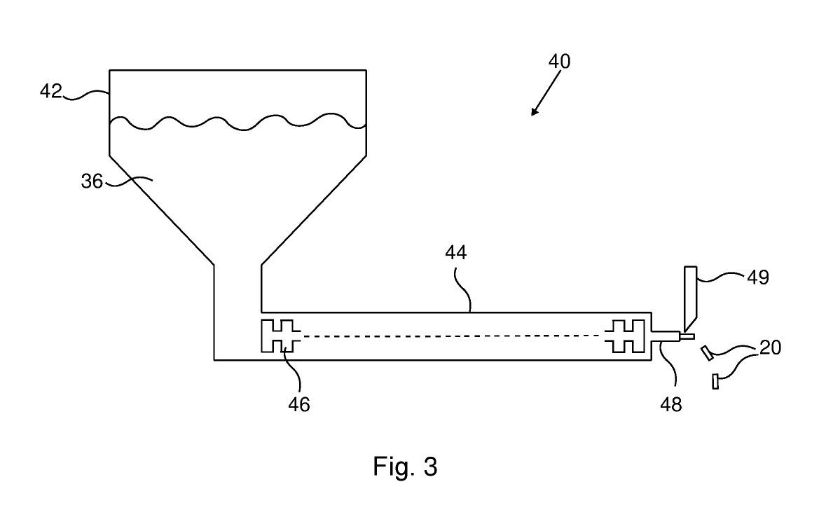

FIG. 3 shows a schematic, partially cutaway side view of a preferable exemplary embodiment of the extruder participating in the method according to the invention,

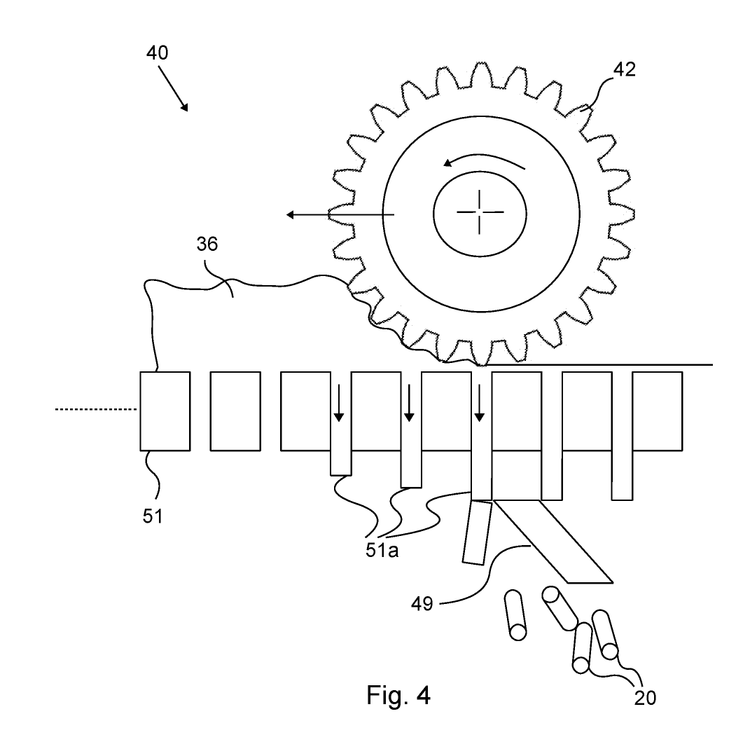

FIG. 4 shows a schematic, partially cutaway side view of another preferred embodiment of the extruder participating in the method according to the invention.

FIG. 1 shows a schematic perspective view of a preferred embodiment of a drinking straw 10 according to the invention. In the case of the depicted embodiment the drinking straw includes a first tubular end portion 10a, a second tubular end portion 10b, an elongate tubular container portion 10c, a first branched portion 12a connecting the first tubular end portion 10a and the container portion 10c, and a second branched portion 12b connecting the second tubular end portion 10b and the container portion 10c. The drinking straw 10 may be made from a traditional drinking straw that has a typical internal diameter of between 7-9 mm, preferably between 7.5-8.5 mm. In the case of a preferred embodiment the length of the end portions 10a, 10b is between 1-2 cm, which, in this way, may be comfortably taken into the mouth. The drinking straw 10 as well as its end portions 10a, 10b, its container portion 10c and its branched portions 12a, 12b are determined by a delimiting wall 16 that has a first end 14a and a second end 14b. The first tubular end portion 10a neighbours the first end 14a of the drinking straw 10, while the second tubular end portion 10b neighbours the second end 14b of the drinking straw 10.

The branched portions 12a, 12b determine at least two, but preferably 3-5 parallel passages 17 (see FIG. 1b), which provide a connection that liquid may pass through between the first tubular end portion 10a and the container portion 10c, as well as between the second tubular end portion 10b and the container portion 10c. The parallel passages 17 of the first and second branched portions 12a, 12b are defined by the neighbouring recesses 18 formed in the wall 16 of the drinking straw 10 and by the inner seam 19 that holds the internal points of the neighbouring recesses 18. The first and second branched portions 12a, 12b may be formed according to that stated in patent application number WO2014076514 for example.

In the case of the present embodiment, the elongate container portion 10c provides liquid communication between the parallel passages 17 of the first and second branched portions 12a, 12b. The central container portion 10c is partially or completely filled with edible particulate product 20 consisting of numerous pieces.

The particulate product 20 comprises at least one type of soluble active ingredient, which continuously dissolves in the liquid (beverage) sucked through the drinking straw 10. In the context of the present invention an active ingredient means a material that changes the colour or taste of the liquid passing through the drinking straw 10, or that exerts a physiological or organoleptic effect during consumption. Such an active ingredient may be, for example, natural colorant, or artificial colorants used in the foodstuffs industry, spices, cocoa powder, flavours, aromas, sweeteners, coffee, herb extracts and additives, minerals, vitamins, medicines, medicine excipients, nutrition additives, energy additives, proteins and similar materials. The sweeteners may be natural sweeteners, such as, for example, honey, beet sugar, fructose, cane sugar, malt syrup, glucose syrup, etc., or artificial sweeteners used in the foodstuffs industry, such as saccharine, aspartame, sodium cyclamate, potassium acesulfame, etc.

The particulate product 20 contains extruded particles with a homogenous structure that preferably have a cylindrical body shape. In the context of the present invention cylindrical body shape means a body that is obtained by circumscribing the periphery of a planar figure with a straight line that has a single common point with the plane of the base sheet, such that the straight line remains parallel with itself, and the mantle obtained is cut along a plane parallel to the original planar figure. The base of the cylindrical body shaped particles 20a, 20b, 20c, 20d of the particulate product 20 may be circular, rectangular, star-shaped or any desired planar figure, as may be seen in FIGS. 2a, 2b, 2c and 2d.

Preferably the effective diameter of the majority of the homogenous extruded particles 20a, 20b, 20c, 20d of the particulate product 20 is 15-25% of the inner diameter of the container portion 10c. As the particles 20a, 20b, 20c and 20d have a cylindrical body shape, several diameters may be defined. The defined and henceforward used effective diameter means the diameter of the largest circular opening through which the given particle 20a, 20b, 20c and 20d does not pass through (rotated in any arbitrary direction).

The homogenous extruded particles 20a, 20b, 20c, 20d preferably contain sugar, starch and active ingredient. It was found to be especially preferable if the composition of the homogenous extruded particles is: 60-80 mass % sugar, 10-20 mass % starch (for example corn starch), and maximum 20 mass % active ingredient. If cocoa powder is also used among the active ingredients as a flavouring material, then the sugar content may be lower, and one or more types of artificial sweetener may be used to increase the sweetness of the particles 20a, 20b, 20c, 20d.

As a consequence of the production method to be presented below, the particles 20a, 20b, 20c, 20d have a homogenous structure and a cylindrical body shape. The cylindrical body shape of the particles 20a, 20b, 20c, 20d involves numerous advantages, if they are used for flavouring in the drinking straw 10 according to the invention or as a filler emitting other active ingredients. Such a particulate product 20 has a greater surface area than a sphere with the same volume. The increased surface area increases the dissolving of the active ingredients into the liquid sucked through the drinking straw 10. The cylindrical body shape of the particulate product 20, which is significantly different from a spherical shape, also ensures that the particulate product is filled less tightly, so more space remains between the particles 20a, 20b, 20c, 20d of the particulate product 20. This improves the flow characteristics, which also means less resistance to the flow of liquid, in other words a lower pressure difference is developed between the two ends 14a, 14b of the drinking straw 10 while the liquid is progressing upwards in the drinking straw 10. In this way the user has to exert less suction force in order to suck up the liquid, which is especially preferable in the case of small children users. A further advantage is that it is less probable that the particulate product 20 according to the invention blocks up any of the liquid-permeable closing elements which retain the particulate product 20 in the drinking straw 10, as the cylindrical body shape substantially remains even during the gradual dissolving process. Contrary to this spherical shaped particles become increasingly tightly packed as their diameter drops, and so they are prone to block up the closing elements after a certain amount of time.

In the following a particularly preferred embodiment of the method of producing the particulate product 20 is presented with reference to FIGS. 3 and 4.

Firstly an edible dry ingredient 30 and an edible wetting ingredient 32 are mixed together, creating an edible homogenous bulk material 36. The edible dry ingredient 30 is preferably in the form of a powder, due to this various other additives and auxiliary materials may be added and homogenously distributed in the product. Materials accelerating and slowing dissolving may also be added to the edible dry ingredient 30. Such auxiliary materials may be, for example, salts used for dietary supplements, minerals (for example magnesium, calcium), vitamins and other dietary supplements. The mixing of the ingredients 30, 32 may take place in a rotating mixing vessel that is commonly used for mixing particles or granulates in the foodstuffs industry, or by using any desired mixing equipment. The edible wetting ingredient 32 preferably contains glucose syrup and/or water, but apart from these any edible wetting liquid can be imagined, like, for example, liquid colorant, liquid sweetener (for example honey), liquid aromas, or other binding material, etc.

Among the ingredients 30, 32 used for producing the particulate product 20 according to the invention, at least one of them contains at least one type of active ingredient, which may be, for example, an artificial colorant used in the foodstuffs industry, spices, cocoa powder, flavouring materials, aromas, sweeteners, coffee, herbal extracts and additives, minerals, vitamins, medicines, medicine excipients, dietary supplements, energy additives, proteins, etc.

In the case of an especially preferred embodiment of the method according to the invention the edible homogenous bulk material 36 is produced by:
firstly mixing edible dry ingredient 30 until is it homogenous creating an edible homogenous mixture 34,
then the edible homogenous mixture 34 is wetted by edible wetting ingredient 32 being added to the edible homogenous mixture 34.

The advantage of this method is that the edible dry ingredient 30 may be more easily and quickly mixed to be homogenous without adding the edible wetting ingredient 32. The edible wetting ingredient 32 is only added to the edible dry ingredient 30 at the end of the mixing process. The adding, with regard to the ingredients, may also take place gradually while the mixture is being continuously or intermittently mixed.

Following this the edible homogenous bulk material 36 is pressed (extruded) through an extruder tube 41. The extruding process is presented in detail below with the help of FIGS. 3 and 4.

FIG. 3 shows an extruder 40 serving to produce a preferred embodiment of the particulate product 20 according to the invention. The extruder's 40 main components include the funnel 42 for filling the edible homogenous bulk material 36, the extruder tube 44 and the extruder screw 46 disposed therein. The extruder tube 44 ends with an end portion 48 that has the profile according to the desired particle cross-section.

As the first step of the extruding process, the edible homogenous bulk material 36 is filled into the funnel 42, which guides the edible bulk material 36 into the extruder tube 44. The edible bulk material 36 in the extruder tube 44 is propelled through the extruder tube 44 by the extruder screw 46. The extruder screw 46 does not only propel the edible bulk material 36, it also presses it through the end portion 48 located at the end of the extruder tube 44. After this the edible bulk material 36 pressed through the end portion 48 is then cut up into appropriate sections by a cutting knife 49 creating the extruded particles 20a, 20b, 20c, 20d.

FIG. 4 shows a partially cutaway outline side view of another preferred embodiment of the extruder 50 participating in the method according to the invention. The extruder 50 contains a press roll 52, at least one or preferably more extruder plate 51 and a cutting knife 54. One or more extruder tubes 51a are formed in the extruder plate 51. In the case of the presented embodiment, the extruder plate 51 is formed as a flat matrix, but a ring matrix or other type of extruder plate 51 may also be used, which is obvious for a person skilled in the art.

In the case of the present embodiment, the circular cross-section press roll 52 rolls on the extruder plate 51, but another solution may also be imagined where the press roll 52 is parallel with the extruder plate 51 but rolls on an imaginary plane displaced from it, in other words the press roll 52 does not come into contact with the extruder plate 51 but instead it rotates above it. In a given case the surface of the press roll 52 is ribbed, which promotes the edible bulk material 36 getting between the press roll 52 and the extruder plate 51. The extruder plate 51 is preferably made from hard, tempered material (for example chrome steel). The extruder tubes 51a may be formed in the material of the extruder plate 51 by drilling, etching or other material working technique, as is obvious for a person skilled in the art. Preferably the cross-sectional profile of the extruder tube 51a is constant along the entire length of the extruder tube 51a, which profile may be circular, rectangular, rhombus or star shaped, or any other planar shape.

As the first step of the extruding process, the plastic, edible homogenous bulk material 36 is placed on the press roll 52 side of the extruder plate 51 (for example, fed with a feed screw). Following this, as a consequence of the movement of the press roll 52, the edible homogenous bulk material 36 between the press roll 52 and the extruder plate 51 is pressed through the extruder tubes 51a under the press roll 52 due to the effect of the pressure exerted by the press roll 52, as a result of which the pressed edible homogenous bulk material 36 takes on the shape of the extruder tube 51a. Following this the edible homogenous bulk material 36 pressed through the extruder plate 51 is cut up into sections preferably of a length of between 1-5 mm, even more preferably into sections of a length of between 1.5-3 mm using the at least one cutting knife 54 disposed on the side of the extruder plate 51 opposite to the press roll 52, thereby creating extruded particles 20a, 20b, 20c, 20d.

Preferably the cutting knife 54 moves in unison with the press roll 52, a little behind it in the direction of movement, in this way the edible homogenous bulk material 36 pressed through by the press roll 52 may be cut up into the desired size in the shortest time.

During pressing the temperature of the edible homogenous bulk material 36 may rise, furthermore, in this state the edible homogenous bulk material 36 is not solid due to the edible wetting ingredient 32 added previously. For these reasons it may be necessary to dry, or, in a given case, cool the particles 20a, 20b, 20c, 20d made from the pressed edible homogenous bulk material 36. The drying, and, in a given case, the cooling may take place passively by spreading out the particles 20a, 20b, 20c, 20d in a room at the appropriate temperature and humidity, or by using a rotating drum known to a person skilled in the art, where during the process the particles 20a, 20b, 20c, 20d, after coming into contact with the environmental air, lose a significant proportion of their moisture content, so gaining their final solidity.

In the case of a preferred embodiment of the method according to the invention, the unevenness on the surfaces of the particles 20a, 20b, 20c, 20d is removed with further polishing and/or de-burring processes. A possible method for this is that the particles 20a, 20b, 20c, 20d are placed in a rotating drum for a given amount of time, during which the particles 20a, 20b, 20c, 20d rubbing up against each other polish each other's surfaces, but, naturally, other polishing and/or de-burring processes may be used, as is obvious to a person skilled in the art. As a consequence of such polishing and/or de-burring processes the particles 20a, 20b, 20c, 20d may lose their original cylindrical body shape and gain a slightly rounded shape, but preferably, even in such a case, the particles 20a, 20b, 20c, 20d remain in a non-spherical shape. The slightly rounded particles 20a, 20b, 20c, 20d may be filled into the drinking straw 10 more easily.

It was found that during the extruding, drying and polishing processes, powder-like, fragmented particles may be created, therefore it is preferable to sieve the particulate product 20 through a sieve with apertures of at least 1 mm, preferably at least 1.5 mm in size. After sieving, the fraction of the particulate product 20 that did not fall through the sieve is used as the filler for the drinking straw 10.

During the next step the extruded particles 20a, 20b, 20c, 20d are filled into the container portion 10c of the drinking straw 10.

Following, before or in parallel with the filling process the ends of the container portion 10c of the drinking straw 10 are closed with a liquid-permeable closing element (for example with the parallel passages 17 of the branched portions 12a, 12b).

In the case of a preferred embodiment the first branched portion 12a is formed at one end of the container portion 10c of the drinking straw 10. Following this the particulate product 20 is filled from the second end 14b of the drinking straw 10 at the opposite end of the container portion 10c, then the other end of the container portion 10c is also closed by creating the other second branched portion 12b.

In the case of another embodiment the particulate product 20 is filled into the container portion 10c, then both ends of the container portion 10c are closed by creating the branched portions 12a, 12b. In a given case it is also possible that the container portion 10c is dimensioned so that several drinking straws 10 may be made from it. In this case the entire length of the container portion 10c is filled with particulate product 20, then branched portions 12a, 12b are created at alternating distances (long and short) along the length of the container portion 10c. After the branched portions 12a, 12b have been created the container portion 10c is cut between the branched portions 12a, 12b closest to each other, making with this one or more drinking straws 10.

Recipes

### EXAMPLE 1

87 mass % sugar powder, 3 mass % dextrose and 10 mass % corn starch were filled into a rotating drum mixer, which ingredients were then mixed to a homogenous powder. Wetting ingredient 32, with a dry material content of approx. 73 mass %, and containing approx. 25 mass % glucose syrup, 50 mass % sugar and 25 mass % water, as well as strawberry flavouring and artificial colour was gradually added to this mixed powder. The adding of the edible wetting ingredient 32 was continued while continuously mixing the mixture until the composition of the materials added into the rotating drum became the following: approx. 15 mass % binding syrup (calculated using the original net weight) and approx. 85 mass % powder, thereby obtaining a plastic edible homogenous bulk material 36.

### EXAMPLE 2

The method according to example 1 was followed with the difference that the binding syrup did not contain aroma or colorant, and the powder contained 75 mass % sugar powder, 3 mass % dextrose, 2 mass % cocoa powder and 10 mass % starch in the interest of producing cocoa flavoured particulate product 20.

In the case of a preferred exemplary embodiment, the edible homogenous bulk material 36 contains at least 5 mass % starch, preferably 10-15 mass % corn starch.

The advantage of the present pressing method is that even completely sugar free products may be created, which was not possible in the case of the earlier dragée technology.

Various modifications to the above disclosed embodiments will be apparent to a person skilled in the art without departing from the scope of protection determined by the attached claims.

1: Drinking straw (10) comprising:
a tubular bordering wall (16), which has an elongate container portion (10c) defining an internal diameter and opposite open ends (14a, 14b),
a particulate product (20) disposed within the container portion (10c), said particulate product (20) containing at least one active ingredient for progressively adding the active ingredient to a liquid passing through the drinking straw (10), and
liquid-permeable closing elements defining the container portion (10c) and retaining the particulate product (20) in the container portion (10c),
characterised by that the particulate product (20) comprises extruded particles (20a, 20b, 20c, 20d) with a homogenous structure.

2: The drinking straw (10) according to claim 1, characterised by that the particulate product (20) comprises cylindrical body shaped particles (20a, 20b, 20c, 20d).

3: The drinking straw (10) according to claim 1, characterised by a majority of said extruded particles (20a, 20b, 20c, 20d) having an effective diameter which is 15-25% of the internal diameter of the container portion (10c).

4: The drinking straw (10) according to claim 1, characterised by that the internal diameter of the drinking straw (10) is between 7-9 mm, preferably between 7.5-8.5 mm.

5: The drinking straw (10) according to claim 1, characterised by that the extruded particles (20a, 20b, 20c, 20d) with a homogenous structure comprise sugar and starch.

6: The drinking straw (10) according to claim 1, characterised by that the extruded particles (20a, 20b, 20c, 20d) with a homogenous structure comprise:
60-80 mass % sugar,
10-20 mass % starch, preferably 10-20 mass % corn starch, and
a maximum of 20 mass % of at least one active ingredient.

7: The drinking straw (10) according to claim 1, characterised by that the closing elements are branched portions (12a, 12b) of drinking straw (10), each having at least two parallel passages (17)—defined by neighbouring recesses (18) formed in the wall (16) of the drinking straw (10) and by an inner seam (19) connecting the neighbouring recesses (18)—and dimensions of the particulate product (20) as well as the cross-section of the parallel passages (17) preventing the particulate product (20) from passing through the parallel passages (17) of the branched portions (12a, 12b).

8: The drinking straw according to claim 7, characterised by that the wall (16) has two tubular end portions (10a, 10b) adjacent the branched portions (12a, 12b), and terminating at the opposite open ends (14a, 14b), and that the length of said tubular end portions (10a, 10b) is between 1-2 cm.

9: The drinking straw (10) according to claim 6, characterised by that the at least one active ingredient is chosen from the group consisting of natural colorants, artificial colorants used in the foodstuffs industry, spices, cocoa powder, flavourings, aromas, sweeteners, coffee, herb extract and additives, minerals, vitamins, medicines, medicine excipients, dietary additives, energy additives and proteins.

10: Method for the production of a drinking straw (10) filled with a particulate product (20), characterised by:
mixing edible dry ingredients (30) with an edible wetting ingredient (32) and creating an edible homogenous bulk material (36),
pressing the edible homogenous bulk material (36) through an extruder tube (44),
cutting up the edible homogenous bulk material (36) pressed through the extruder tube (44) into the particulate product (20),
introducing the particulate product (20) into a container portion (10c) of the drinking straw (10), and
closing opposite end portions of the container portion (10c) of the drinking straw (10) with liquid-permeable closing elements.

11: The method according to claim 10, characterised by that the edible homogenous bulk material (36) is created by:
firstly mixing edible dry ingredient (30) until is it homogenous and creating an edible homogenous mixture (34) and thereafter,
wetting the edible homogenous mixture (34) by adding an edible wetting ingredient (32) to the edible homogenous mixture (34).

12: The method according to claim 10, characterised by pressing the edible homogenous bulk material (36) wherein the extruder tube (44) is in an extruder plate (51).

13: The method according to claim 10, characterised by that the edible homogenous bulk material (36) comprises at least 5 mass % starch.

14: The method according to claim 10, characterised by that the edible wetting ingredient (32) comprises glucose syrup and/or water.

15: The method according to claim 10, characterised by that the edible homogeneous bulk material (36) includes at least one active ingredient, selected from the group consisting of natural colorants, artificial colorants used in the foodstuffs industry, spices, cocoa powder, flavourings, aromas, sweeteners, coffee, herb extract and additives, minerals, vitamins, medicines, medicine excipients, dietary additives, energy additives and proteins.

16: The method according to claim 10, characterised by sieving the particulate product (20) using a sieve with square openings of at least 1 mm, preferably at least 1.5 mm, and filling the drinking straw (10) with particulate product (20) retained by the sieve.

17: The method according to claim 10, characterised by drying the particulate product (20) before being introduced into the drinking straw (10).

18: The method according to claim 10, characterised by that the particulate product (20) is between 1-5 mm, preferably between 1.5-3 mm, long.

19: The method according to claim 10, characterised by deburring the particulate product (20) before the particulate product (20) is introduced into the drinking straw (10).

20: The method according to claim 10, characterized by that the edible homogeneous bulk material comprises 10-15 mass % corn starch.
